(19) United States
(12) Patent Application Publication
(10) Pub. No.: US 2003/0195937 A1
(43) Pub. Date: Oct. 16, 2003

(54) Intelligent message screening

(75) Inventors: Robert C. Kircher JR., Seattle, WA (US); Surendra Bhatia, Kent, WA (US)

Correspondence Address: LAW OFFICES OF RONALD M ANDERSON, 600 108TH AVE, NE, SUITE 507, BELLEVUE, WA, 98004, US

(73) Assignee: Kontact Software Inc.

(21) Appl. No.: 10/124,750

(22) Filed: Apr. 16, 2002

(51) Int. Cl. G06F 15/16

(52) U.S. Cl. 709/207

(57) ABSTRACT

Electronic messages are processed based on criteria relating to the sender, the content, and the personalization of the message. The content of the messages, the recipient's address book, and parameters such as desired keywords and undesired keywords are employed in determining a numeric ranking for each message. Based upon the ranking, messages are assigned to a category indicating an expected response of the recipient, such as read, reply, and save, or simply read. Messages in the lowest category (spam) are marked for deletion. Fuzzy logic is preferably applied in determining the category to which a message is assigned based on its ranking. Content importance, sender importance, and degree of personalization are combined in a non-linear manner to rank a message. Based on the recipient's actual response to a message, the priority of subsequent similar messages is adjusted to more accurately assign the messages to a category.

### FIELD OF THE INVENTION

This invention relates generally to communications over a network, and more particularly, to a method and apparatus for processing electronic messages conveyed over a network, based on predefined criteria such as the sender of the message and the content of the message, where the recipient's response to and handling of current messages affects the automated processing of future messages.

### BACKGROUND OF THE INVENTION

Electronic messaging system traffic has increased dramatically in the past twenty years. The introduction of mobile and cellular telephone systems increased the utility of the telephone systems, and traffic on such systems has correspondingly increased. Fax machines have become ubiquitous in both business and personal applications, further increasing the use of electronic messaging for transmitting hard copies of documents. But the greatest growth in electronic messaging has occurred due to the advent of email communications between personal computers over the Internet (and other networks). It is not uncommon for individuals in a busy work environment to receive hundreds of email messages each day. Unfortunately, many of these email messages are spam, i.e., unsolicited email messages from strangers, or of relatively low priority and of little interest to the recipient.

Mixed in with the spam email messages are those that are relatively important, for example, messages from business contacts, friends, or relatives. Electronic messages represent an essential form of communication that cannot be ignored. Indeed, email messaging has become so important in conducting business and in personal communications that many feel obliged to access email messages, even when away from home or the office. As a result, the use of Web enabled pagers, smart phones, and personal digital assistants (PDAs) is becoming widespread, to enable electronic messages to “follow” an individual almost anywhere. However, the display screens available on such portable devices are generally too small to facilitate navigating through a lengthy list of electronic messages. Sorting through hundreds of electronic messages on such a small display to separate the important messages from the spam and relatively unimportant messages is thus both difficult and time consuming.

Several attempts have been made to efficiently manage electronic messages. It is common to apply specific rules to electronic messages, based upon words that appear in the subject or body of the message, or the name or address of the sender, to determine a specific action that should be applied in handling or processing the email. For example, if the subject line of any message includes the phrase “be free of debt,” possibly indicating a spam solicitation from a loan company, the user can invoke a rule that moves the message into a deleted file folder. However, such rules are really too limited in concept to be effective in blocking spam, since a small difference in the phrase “be debt free” will not invoke the rule, as the user might hope. Also, there are times that such rules should not be applied. For example, even though a message includes a word or phrase that is included in a rule to cause the message to be moved to the deleted file folder, it should not be deleted if the message is from a close relative or friend of the recipient.

U.S. Pat. No. 6,147,977 (Thro et al.) describes a method and apparatus that processes messages conveyed over a wireless communication system, based on originator priority and recipient priority. Such messages include an identity of the receiving party, originator priority information, and the message content. Upon identifying the receiving party, a server retrieves recipient priority information for the receiving party and then merges the originator priority information with the recipient priority information to produce a message priority. In addition, the server generates a recipient index, which identifies an address for subsequent retrieval of the message content. Next, the server provides a notice of the message to the receiving party based on the message priority. The notice of the message may be sent to the receiving party's pager, cellular telephone, email account, fax machine, landline telephone, or answering service. The system employs a cumulative weighting function to prioritize messages, but does not “learn” a recipient's preferences based on the recipient's response to the messages. Clearly, it would be desirable to provide a system and method that employ a more useful prioritization paradigm than in this patent.

In U.S. Pat. No. 6,052,709 (Paul), a system and method for controlling delivery of unsolicited electronic mail messages are described. One or more spam probe email addresses are created and planted at various sites on a communications network in order to insure their inclusion on large-scale electronic junk mail (spam) mailing lists. The mailboxes corresponding to the spam probe email addresses are monitored for incoming mail by a spam control center. Upon receipt of incoming mail addressed to the spam probe addresses, the spam control center automatically analyzes the received spam email to identify the source of the message, extracts the spam source data from the message, and generates an alert signal containing the spam source data. This alert signal is broadcast to all network servers and/or all user terminals within the communications network. A filtering system implemented at the servers and/or user terminals receives the alert signal, updates stored filtering data using the spam source data retrieved from the alert signal, and controls delivery of subsequently-received email messages received from the identified spam source. The filtering system controls delivery of the unsolicited email messages by discarding the messages without displaying them to the user, displaying the messages to the user with a “JUNK,” “SPAM,” or similar marker, or otherwise processing the spam mail as desired by the network provider and/or the network users. The filtering system may also filter email messages sent by the user terminals. While useful in filtering out spam, this patent does not assign any priority to non spam messages, and does not “learn” about a recipient's preferences based on the recipient's response to such messages.

Another system for filtering junk emails is described in U.S. Pat. No. 6,023,723 (McCormick et al.). The user compiles a list of email addresses or character strings representing senders from whom the user does not wish to receive messages to produce a first filter. A second filter is generated that includes names and character strings representing senders from whom the user does wish to receive messages. Any email addresses or strings contained in the first filter will be automatically eliminated from the user's system. Any email addresses or strings contained in the second filter are automatically sent to the user's “In Box.” Any email not provided in either of the filter lists will be sent to a “Waiting Room” folder for review by the user at a later time. If this review results in the user rejecting an email message, the address as well as specific character strings included in this email message would be transmitted to a central location to be included in a master list. This master list is periodically sent to each of the users, to update the first filter. Again, while useful in filtering out spam, this patent does not assign any priority to non spam messages, but instead, stores non-spam messages in either the “In Box” or the “Waiting Room” based solely on the identity of the sender. While the patent does contemplate regularly updating the filters, no provision is made to enable a self updating filter. It would be desirable to provide a system and method that prioritizes messages based on more criteria than just sender identity.

Yet another example of a prior art technique related to this problem is described in U.S. Pat. No. 5,619,648 (Canale et al.). A recipient description containing non-address information is added to an email message. The user is provided with an email filter that has access to information that models the user. The email filter uses the non-address information and the model information to determine whether the email message should be provided to the user. The email filter further has access to information that models the user's correspondents. If the filter does not provide the message to the user, it uses the non-address information and the model information of the user's correspondents to determine to whom the message might be forwarded. A sender of email can also use the model information of the sender's correspondents together with the non-address information to determine to whom the message should be sent. These techniques are used in a system for locating a person with a specific expertise. Note that the patent does not disclose a system that either prioritizes or ranks messages (the system is binary, either messages are blocked or passed).

Clearly, despite past efforts to provide systems and methods for managing electronic messages, there is a need for a more efficient system and method than has been achieved in the art. Particularly as noted above, it would be desirable to provide a system and method for ranking incoming messages according to an anticipated response of the recipient (e.g., read, reply, save, or delete a message), as well as being capable of “learning” a recipient's preferences based upon the recipient's response to previous messages, to enable future messages to be more accurately ranked and processed.

### SUMMARY OF THE INVENTION

The present invention is directed to a method for processing electronic messages, to rank messages based upon probable importance to the recipient. The method evaluates the messages based on determinable attributes and user-defined parameters to produce a numerical result corresponding to a ranking of the importance of each electronic message received.

While many methods and systems to filter electronic messages have been used in the past, the problem of filtering out only spam and newsletters, while allowing potentially important messages from an unknown person to be pass through the filter has not been solved. Attempts to filtering email often prevent email from persons other than those specifically identified in a user's address book from being received. Important email from persons not specifically identified will not pass through the filter. One of the principle aims of the present invention is to separate messages from unknown persons from messages from newsletters and messages that are likely spam. This is particularly important because email from unknown persons often represents new business opportunities. Thus a goal of the present invention is to filter out messages that can be identified as spam and newsletters, and then to evaluate messages from unknown persons to determine how likely it is that such messages are important.

Based on determinable attributes of the electronic messages and user-defined parameters, each message is assigned to one of a plurality of different categories, each category corresponding to at least one user action a recipient might logically perform in response to receiving an electronic message. Based upon the ranking of the electronic messages received, each message is then assigned to one of the plurality of categories. Preferably, the method employs fuzzy logic in ranking the electronic messages.

In at least one embodiment of the present invention, the recipient is enabled to select a category, and to apply a function to each electronic message assigned to the selected category. One such function is to display each electronic message in the selected category, and another such function is to delete each electronic message in the selected category.

Preferably, each message is also evaluated to determine the importance of the sender of the electronic message relative to the recipient. In addition, the degree of personalization or content of the electronic message is preferably evaluated with respect to the recipient.

In one embodiment, fuzzy logic is individually employed to determine at least one of a plurality of criteria. Exemplary criteria include the importance of the sender of the electronic message, the degree of personalization of the electronic message with respect to the recipient, and the importance of the content of the electronic message. In another embodiment, each criterion is evaluated before fuzzy logic is employed, and the fuzzy logic is employed to generate a single numerical value corresponding to a ranking of the message's importance based on all the criteria evaluated. In still another embodiment, fuzzy logic is employed both to evaluate each individual criteria, and then to generate a single numerical value corresponding to a ranking of the message's importance based on all the criteria evaluated. In at least one embodiment, the evaluation of the importance of the sender of the electronic message uses at least one of: (a) addressing attributes of the electronic message; (b) subject line attributes of the electronic message; (c) context text attributes of the electronic message; (d) a user defined address book; and (e) a user defined profile. Preferably, when evaluating the importance of the sender of the electronic message, a user profile is employed to determine at least one of: (a) whether the address of the sender of electronic message is in the user's address book; (b) whether the sender of the electronic message is a person; (c) whether the electronic message is a newsletter; and (d) whether the electronic message includes at least one of a nickname, a telephone number, and a company name that is in the user's address book.

The step of determining whether the sender of the electronic message is a person preferably determines whether the electronic message includes the term “unsubscribe.” The step of determining whether the electronic message is a newsletter comprises the step of determining at least one of: (a) whether the electronic message includes the term “unsubscribe;” (b) whether the electronic message is free from specific keywords; (c) whether the electronic message is free from spam clues; and (d) whether the sender of the electronic message is a person.

In at least one embodiment, the step of evaluating the degree of personalization of the electronic message with respect to the recipient includes using at least one of: (a) context text attributes of the electronic message; (b) a user defined address book; and (c) a user defined profile. Preferably, the degree of personalization is determined by at least one of: (a) whether the electronic message is addressed to only to the recipient; (b) whether the electronic message was also sent to any other recipient; (c) whether the sender of the electronic message is a person; (d) whether the electronic message includes a personalized greeting matching the recipient's friendly name; and (e) whether there is a personalized signature matching the sender's friendly name. The step of determining whether the sender of the electronic message is a person includes determining at least one of: (a) whether the sender has a legal address for receiving electronic messaging; (b) whether the sender has a friendly name; and (c) whether the sender's legal address for receiving electronic messaging is in the recipient's address book.

In embodiments that evaluate the importance of the content of the electronic message, this step employs at least one of: (a) subject line attributes of the electronic message; (b) context text attributes of the electronic message; (c) a user defined address book; and (d) a user defined profile. Preferably, a determination of importance is made based upon whether the electronic message includes spam clues, newsletter clues, exceeds a specified number of words, includes a personalized greeting matching the recipient's friendly name, includes a personalized signature matching the sender's friendly name, includes keywords that are not among predefined keywords, and includes at least one of a nickname, a telephone number, and a company name in the recipient's address book.

Preferably, the method includes the step of determining what user action the recipient performed in response to receiving the electronic message, and if that response does not correspond to the category to which the electronic message was assigned, updating determinations based on attributes of electronic messages and user defined parameters, so that future electronic messages will be more accurately assigned to a category.

In yet another embodiment, the ranked and categorized electronic messages are forwarded to a portable device, such as a wireless phone, a pager, or a person digital assistant. Preferably, only those electronic messages corresponding to a category that includes the recipient reading the electronic message are forwarded in this manner.

Other aspects of the present invention are directed to a storage medium on which is stored a plurality of machine instructions defining a computer program. When the plurality of machine instructions are executed by a processor, they cause the processor to execute steps generally consistent with method described above. Still other aspects of the present invention are directed to a system for ranking the importance of electronic messages before the electronic messages are reviewed by the recipient. The system includes a memory in which a plurality of machine instructions defining an executable application are stored, a display, and a processor that is coupled to the display and to the memory to access the machine instructions. The processor executes the machine instructions, carrying out a plurality of functions generally consistent with the method steps described above.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram illustrating how the present invention prioritizes electronic messages using fuzzy logic;

FIG. 2 is a block diagram of a computing device useful for implementing the present invention;

FIG. 3A is a schematic representation of an email inbox before the contents of the inbox have been prioritized;

FIG. 3B is a schematic representation of an email inbox after the contents of the inbox have been prioritized, in accord with the present invention;

FIG. 4 is a flow chart showing the steps employed for prioritizing electronic messages in accord with the present invention;

FIG. 5A is a flow chart showing the steps employed in a first embodiment that uses fuzzy logic to prioritize electronic messages;

FIG. 5B is a flow chart showing the steps employed in a second embodiment that uses fuzzy logic to prioritize electronic messages;

FIG. 5C is a flow chart illustrating the steps employed for using fuzzy logic to prioritize email messages;

FIG. 6 is a flow chart illustrating steps for importing rules, a table, and message attributes used to prioritize email messages in accord with the preferred embodiment of FIG. 5C;

FIG. 7 is a flow chart showing preferred steps employed for analyzing message content when prioritizing email messages in accord with the preferred embodiment of FIG. 5C;

FIG. 8 is a flow chart showing steps employed for evaluating the importance of the sender of an email message in accord with the preferred embodiment of FIG. 5C;

FIG. 9 is a flow chart showing steps employed for evaluating the importance of the content of an email message in accord with the preferred embodiment of FIG. 5C;

FIG. 10 is a flow chart showing steps employed for evaluating the degree of personalization with respect to the recipient of an email message in accord with the preferred embodiment of FIG. 5C;

FIG. 11 is a flow chart showing steps employed for applying fuzzy logic to criteria including the importance of the sender of the email message, the importance of the content of the email message, and the degree of personalization with respect to the recipient of the email message, when assigning a numerical value corresponding to the importance of the email message, in accord with the preferred embodiment of FIG. 5C;

FIG. 12 is a flow chart showing additional detail regarding use of the importance of an email message in categorizing the email message according to an expected user action; and

FIGS. 13 and 14 are flow charts showing additional details regarding updating rules when an actual user action is different than an expected user action that was determined from the ranking of the email message.

### DESCRIPTION OF THE PREFERRED EMBODIMENT

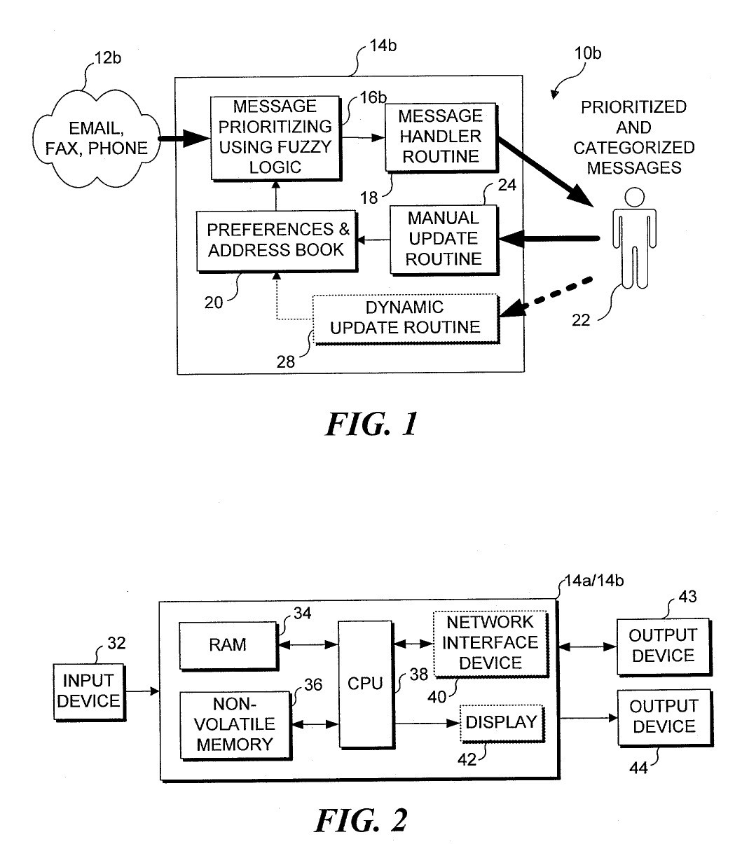

FIG. 1 schematically illustrates functions of the present invention. In a system 10b, email, faxes, and telephone messages comprising electronic messages 12b are received by a computing device 14b. Computing device 14b executes a message handler routine 18 and a manual update routine 24 to implement the present invention, and stores user defined preferences and address book 20, which are accessed when prioritizing the electronic messages. Preferably, the present invention prioritizes the incoming messages using fuzzy logic, as indicated in a block 16b, to determine a category for the messages, which will determine how the electronic messages are handled. The prioritized messages are available to a user 22, who will no longer need to sort through multiple electronic messages to determine which messages have a high priority.

As those of ordinary skill in the art will recognize, the term “fuzzy logic” refers to a mathematical technique for dealing with imprecise data and problems having multiple acceptable solutions, rather than a single solution. Fuzzy logic is often used for solving problems in systems that must react to an imperfect environment including highly variable and volatile or unpredictable conditions. According to traditional logic, an element is either a member of a set or not. According to fuzzy logic, membership in a set is a matter of degree, rather than specific yes/no determination. Fuzzy set theory, which was originally developed by Lotfi Zadeh in the 1960s, resembles human reasoning in that it employs approximate information and uncertainty to arrive at decisions. Fuzzy logic has been specifically designed to mathematically represent uncertainty and vagueness, and to provide formalized tools for dealing with the imprecision intrinsic to many systems.

Fuzzy set theory defines classes or groupings of data with boundaries that are not sharply defined (i.e., boundaries that are fuzzy). Linguistic variables are an important aspect of fuzzy logic applications, as general terms such as “large,” “medium,” and “small” are used to capture a range of numerical values. Fuzzy logic allows sets to overlap. For example, under fuzzy logic, a 200 pound man might be classified in both “large” and “medium” weight categories, with varying degrees of membership in each category. Fuzzy set theory encompasses fuzzy logic, fuzzy arithmetic, fuzzy mathematical programming, fuzzy topology, fuzzy graph theory, and fuzzy data analysis; however, the term fuzzy logic is often used to encompass all of these aspects.

Because fuzzy logic can handle approximate information in a systematic way, it is often used for modeling complex systems where an inexact model exists, or in systems where ambiguity or vagueness is inherent. Typically, a fuzzy system includes a rule base, membership functions, and an inference procedure. Thus, a fuzzy system is a collection of membership functions and rules that are used to reach decisions about data. Generally, the rules in a fuzzy expert system are in a form similar to the following:

IF x is low and y is high THEN z=medium (1)

where x and y are input variables (i.e., known data), z is an output variable (i.e., data to be computed), “low” is a membership function (fuzzy subset) defined on x, “high” is a membership function defined on y, and “medium” is a membership function defined on z. The part of the rule between the IF and THEN is the rule's _premise_or _antecedent_. Such a fuzzy logic expression describes to what degree the rule is applicable. The portion of the rule following THEN is the rule's _conclusion_or _consequent_. That portion of the rule assigns a membership function to each of one or more output variables. Frequently, more than one conclusion per rule is allowed.

Systems utilizing fuzzy logic typically include more than one rule. An entire group of rules is collectively known as a _rulebase_or _knowledge base_.

Referring once again to FIG. 1, logic module 16b not only prioritizes (i.e., filters) the incoming messages, it also categorizes the messages according to actions a user will logically take in response to receiving an electronic message. For example, an important message is likely to be read, saved, and replied to. Other messages of perhaps lesser import are likely to be read and saved. Messages of little importance will not be read, or will be deleted. In one preferred embodiment of the present invention, the logic executed in block 16b prioritizes electronic messages, and then separates the messages into different categories based on each message's individual ranking. The categories employed each relate to a different user action expected to be taken in response to the receipt of the electronic message. In an alternate embodiment, fuzzy logic is employed to prioritize the messages, but is not used to categorize each message based on the priority determined. For example, Boolean logic rather than fuzzy logic might be used to categorize each message based on its ranking.

An optional feature of the present invention is a dynamic update routine 28 that enables the system to learn and refine the choice of categories to which an electronic message is assigned in the future, based on a user's response to a message that was forwarded to the user. If it is determined by the system that the user did not desire to receive the message, the preferences and address book 20 are automatically updated to change the category assigned to similar messages so that future messages are processed with a greater degree of accuracy in regard to predicting the likely action by the user in response to such messages. As described in more detail below, the dynamic updating is enabled by monitoring a user's actual response to receiving an electronic message. If the actual response (e.g. reading the message, deleting the message, replying to the message) is different than the expected response corresponding to the category selected in the logical process of block 16b, then the dynamic updating makes changes to the user's preferences and address book 20. The information in user's preferences and address book 20 is used by the logic of block 16b when prioritizing electronic messages, so updates to user's preferences and address book 20 will affect the result obtained by the logical process executed in block 16b. Those of ordinary skill in the art will readily recognize that an address book will generally contain more information than just email addresses. For example, in addition to email addresses, address books often contain nicknames, company names, and telephone numbers. It should be understood that present invention will preferably parse each item of electronic mail looking for any content that corresponds to an entry in the user's address book, including and not limited to email addresses, nicknames, company names, and telephone numbers. Specific examples of how information in a user's address book is used to evaluate an electronic message is provided below.

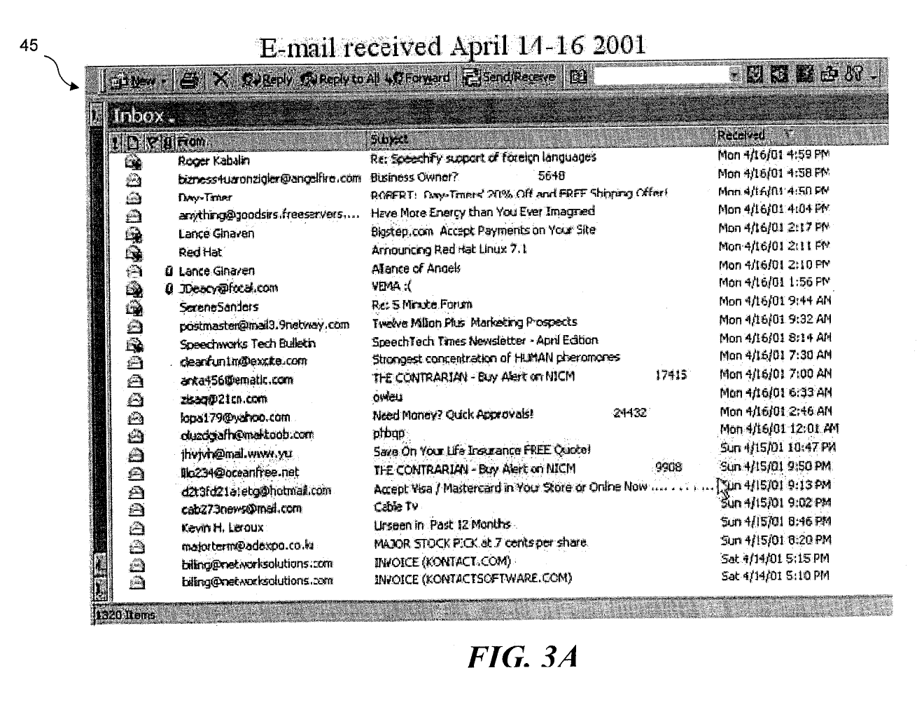

FIG. 2 illustrates a computing device 14a/14b that is useful for implementing the present invention. It is contemplated that the computing device might be any of a number of different types of devices for processing electronic messages, including for example and without limitation, a personal computer, a voicemail machine, a portable telephone with message handling capability, a Personal Digital Assistant (PDA), and a tablet computer. The computing device includes a central processing unit (CPU) 38, random access memory (RAM) 34, and a nonvolatile memory 36. Optionally, a network interface device 40, and an integrated display 42 are included. Machine instructions for implementing the message prioritizing logic of block 16b, message handler routine 18, and manual update routine 24, and the content of preferences and address book 20 are stored in nonvolatile memory 36. If dynamic update routine 28 is part of the embodiment, machine instructions for implementing the update routine will also be stored in nonvolatile memory 36. Network interface device 40 has been indicated as an optional device, because it may alternatively be external to the computing device. It should be understood that computing device 14a/14b is not limited to any particular type of network interface. Any network interface device, internal or external, that enables computing device 14a/14b to receive and process an electronic message transmitted over some form of network (e.g., email, voice data, and fax data) can be employed. Integrated display 42 is indicated as an optional device, because many computing devices, such as desktop personal computers, use a peripheral display, while other computing devices, such as Smart Phones, PDAs, lap top computers, and pagers include an internal display. An input device 32, such as a keyboard, keypad, pointing device, or other source, is used to introduce data into computing device 14a/14b. An output device 44, such as a peripheral display, speaker, earphone, or printer, is used to communicate data to a user. Additionally, an output device 43, such as a modem or transmitter, can be used to transmit prioritized and categorized electronic messages to a user at a remote location.

As noted above, one important goal of the present invention is to enable spam and newsletters to be filtered, while allowing potentially important messages from an unknown person to be pass through the filter. The present invention is based on an exhaustive analysis of email from unknown senders including important content, and email corresponding to spam and newsletters. As will be described in detail below, an important aspect of the present invention is determining how to quantify the senders “importance”. Preferably, senders of spam and newsletters will be ranked as being unimportant, while unknown persons sending important content should be ranked as much more important. The present invention enables the senders importance to be defined by user defined parameters (i.e. a specific sender is positively identified in a user's address book), as well as by clues found in the content of the email. For example, even if a specific sender is not identified in a user's address book, if anyone carbon copied to the email message is identified in a user's address book, the sender of the email is assumed to be important to the user, as the sender is somehow related to the user's community (those identified in the user's address book). Similarly, if the content of the email indicates that the sender is replying to an email sent by the user, the sender is also assumed to be important to the user. Other clues that are used to evaluate the importance of an email are based on characteristics of spam, newsletters, and the anticipated content of an important message. One type of message that the present invention presumes to be very important to a user is a message from an unknown person who appears to be attempting to contact the user regarding a business transaction. Such communications will often include, within the content of the email (as opposed to the from or about portions of the message), the sender's name, the sender's postal address, the sender's email address, the sender's friendly name, and/or the sender's telephone number. The present invention recognizes that such an email message can be distinguished from spam or newsletters by applying different clues. For example, while spam sometimes includes a closing including the name of a person (e.g. “Thanks, Bob”) to emulate a personalized communication, such a name generally does not correspond to the friendly name linked to the sender of the spam's email address. Similarly, spam generally does not include within its content the email address of the sender of the spam, so the domain of the sender is not included in the content of spam. The present invention uses such clues, as well as other described below, to separate senders of spam and newsletters from senders that are unknown persons, who quite possibly might be sending messages whose content the user would find important.

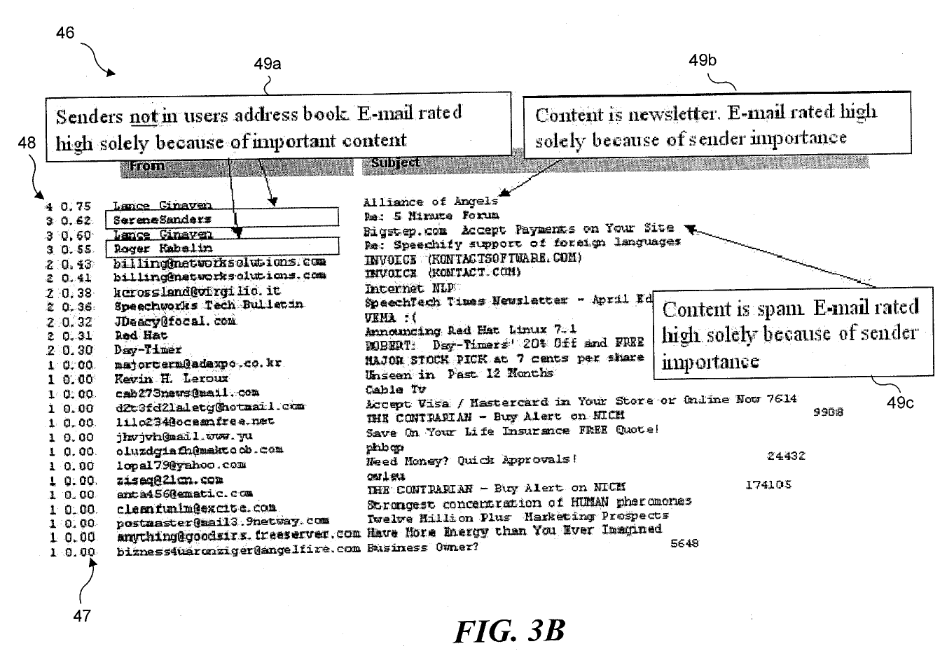

FIG. 3A shows an inbox 45 containing email messages that have not been prioritized in accord with the present invention. Each message is included in the inbox, in the order in which the messages were received. A user must scan the entire list of messages to determine those messages that are important enough to read and possibly save, those that are moderately important that can be read and deleted, and those messages that are spam and should preferably be deleted without further regard. FIG. 3B shows an email inbox 46 in which the contents of the inbox have been prioritized in accord with the present invention. In inbox 46, the messages have been ranked according to the likely importance of each message to the recipient, as determined by a logical process described in detail below. Thus, a user merely has to scan the portion of the inbox representing the most important messages. If the user desires, the unimportant messages can readily be ignored. It is further contemplated that the present invention can be optimized so that messages having a low ranking are not even displayed to a user, but are instead automatically deleted.

A column 48 indicates the importance of each email by a ranking number determined by a logical process. In this preferred embodiment, emails having a ranking number four (4) are considered to be most important; emails having a ranking number three (3) are considered somewhat less important; and emails having a ranking number two (2) are still less important. Emails having a ranking number one (1) are considered relatively unimportant. Optionally, emails having a ranking of one do not need to be shown to a user. It will be understood that either more or fewer ranking numbers can alternatively be employed in accord with the present invention.

A column 47 includes the numerical value assigned to each email message according to the logical process, which in one preferred embodiment is determined using fuzzy logic. Note that these values range from zero to one. It should be understood, however, that any range, such as zero to 100, could alternatively be employed.

In column 48, the numerical value corresponds to an expected user action in regard to the email message, while the number in column 47 indicates the ranking of the email. Note that emails assigned to the same category in column 48 can have different rankings, since the category can cover a range of rankings.

In a preferred embodiment of the invention, four expected user actions are represented by the categories, a different user action being associated with each category. A first expected user action associated with category one in column 48 is that a recipient will delete that particular email without reading the email. Such an action would typically apply to spam messages. Category two in column 48 indicates that the recipient is expected to save the email message. Category three in column 48 indicates that the recipient is expected to read and save the email message. The fourth category is assigned to email messages that the recipient is expected to read, reply to, and save. It should be noted that the present invention preferably enables a user to define how messages in each category will be handled. For example, the user may decide that all messages in category one should be automatically deleted and all messages in category two should be automatically saved. Alternatively, as illustrated in inbox 46 all messages, regardless of the category to which they are assigned, can optionally be made available for a user to review, after being arranged in the order of their ranking, so that the most important messages appear first, regardless of when a message was received. This versatility enables a user to selectively view only the most important messages when accessed using a device that has a relatively small display, such as a Smart Phone, or PDA. When using a computer monitor to view the messages, the user might elect to also view messages of lower importance.

The present invention enables messages to be ranked differently than has been done in prior art message handling systems. For example, a block 49a refers to an email message from a sender that is not in the user's address book. That email was rated high solely because the logic executed in block 16b determined that the content of the email message was very important. In prior art systems, email messages from unknown senders are sometimes simply blocked (on the basis that they are likely of low importance). In block 49b, the system has identified an email as a newsletter from a sender that the user's preferences have identified as being important. Prior art systems typically rank newsletters as being of low importance, regardless of the sender. An email indicated by block 49c has been determined to be unsolicited advertising, i.e., spam. Generally, email identified as spam is considered of low importance and may even be automatically deleted. In the present example, the email has been ranked highly important solely because of the importance of the sender who is a close relative of the recipient.

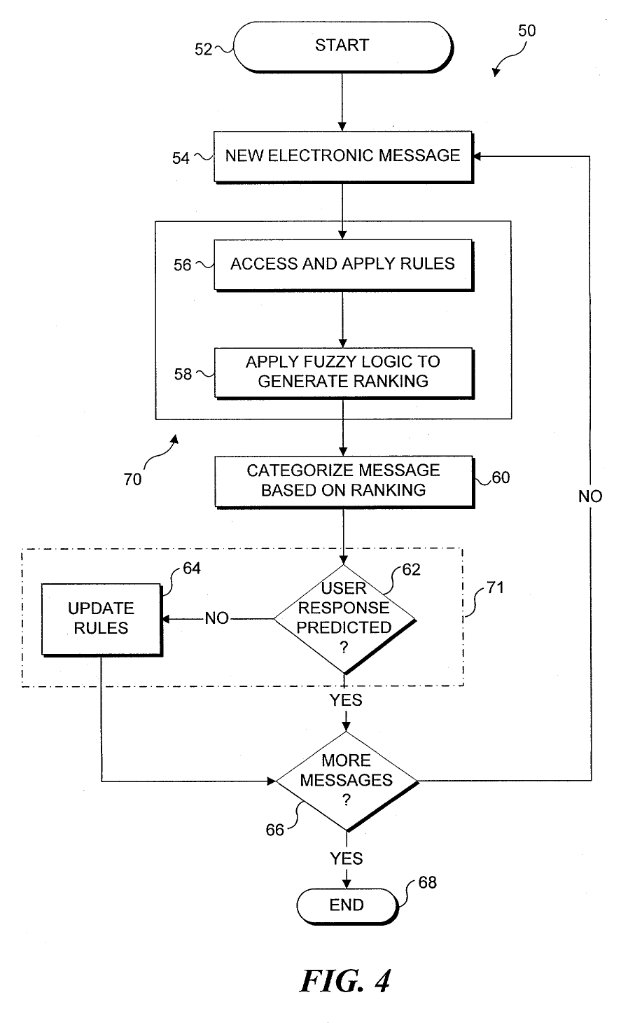

FIG. 4 includes a flow chart 50 illustrating the logic employed in a preferred embodiment of the present invention. This logic utilizes fuzzy logic to prioritize the messages and then categorizes the messages based on their priority. As noted above, other embodiments (not specifically shown) are contemplated, which use fuzzy logic to prioritize messages, but do not categorize the messages, as well as embodiments that categorize messages according to expected user actions in responding to the messages, but do not use fuzzy logic in ranking the messages. Referring to FIG. 4, the logic is initialized in a start block 52. New electronic messages are received in a block 54. In a block 56, the system accesses and applies predefined rules collectively known as a _rulebase_or _knowledge base.

In a block 58, fuzzy logic is applied to generate a ranking for that electronic message. Note that blocks 56 and 58 are collectively identified as block 70. As will be discussed in greater detail below, the present invention encompasses several different embodiments for applying rules and fuzzy logic to determine a ranking of an electronic message.

In a block 60, each electronic message is categorized based on the ranking determined by the fuzzy logic. In a block 62 the logic determines whether or not the user response expected by the system actually corresponds to the action taken by a user. For example, if the system determined that an expected user action was to delete an email, and the user actually read and replied to the email, the expected user action differs from the actual user action. In this event, the logic moves to a block 64, and the rules used by the system in determining a ranking for electronic messages are changed so that future messages of this type are properly ranked. If the expected user action matches the actual user action, the logic moves to a decision block 66. Note that blocks 62 and 64 collectively comprise a block 71, which is indicated in dash lines because blocks 62 and 64 collectively represent the dynamic updating process that is an optional, but preferred feature of the present invention.

In block 66, the logic determines whether there are additional electronic messages to prioritize. If so, the logic loops back to block 54. If no other electronic messages are present, the logic moves to an end block 68.

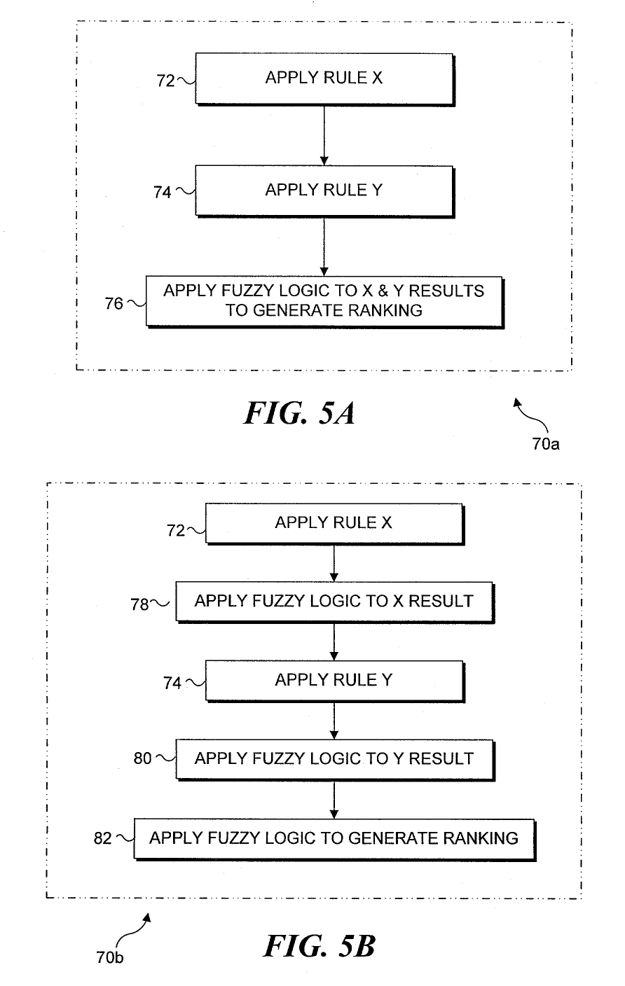

Referring once again to block 70, which collectively includes blocks 56 and 58, FIGS. 5A, 5B, and 5C each illustrate the logic for different embodiments in which the rules are accessed and fuzzy logic is applied to those rules to determine the ranking of electronic messages. In a first embodiment illustrated by a flow chart 70a of FIG. 5A, as noted in a block 72, a rule X is applied to the current electronic message. In a block 74, a rule Y is applied to that electronic message. Then, in a block 76 fuzzy logic is applied to the results of applying the X and Y rules to generate a ranking of that electronic message.

In a second embodiment illustrated by a flow chart 70b of FIG. 5B, as indicated in a block 72, rule X is also applied to an electronic message. In a block 78, fuzzy logic is applied immediately to result X. Then, in block 74, rule Y is again applied to the electronic message, and in a block 80, fuzzy logic is immediately applied to the Y result. In a block 82, fuzzy logic is again applied to the X and Y results that have already had a fuzzy logic process applied to them (blocks 78 and 80), yielding an overall ranking.

It should be noted that the logical steps illustrated in FIGS. 4, 5A, and 5B can be applied to different types of electronic messages, including, for example, faxes, telephone messages, and email messages. Accordingly, the precise nature of the X rule and of the Y rule are not specified in these general flow charts, since the rules applied would depend upon the nature of the actual electronic messages being processed by the present invention. However, FIG. 5C illustrates a flow chart 70c specifically showing greater details of the logic used to evaluate and prioritize email messages. In a block 84, rules, tables, and message attributes are imported into a working memory of the computing device. In a block 86, the message content is analyzed. In a block 88, the message sender is evaluated to determine whether that particular sender has been identified by the user as an “important person.” In a block 90, the message content is evaluated to determine whether the message is of particular importance to a user. In a block 92, the present invention evaluates the degree of personalization in the message to determine whether that email message is likely from an acquaintance of the user. In a block 94, fuzzy logic is applied to the results of the importance of the sender, the importance of the content, and the degree of personalization of the email message, to determine a ranking for that email message. The logical process illustrated in flow chart 70c of FIG. 5C (representing block 70 of FIG. 4), combined with the logical process illustrated in flow chart 50 of FIG. 4, was used to process the in-box illustrated in FIG. 3A to achieve the prioritized and categorized listing of email messages in the in-box of FIG. 3B.

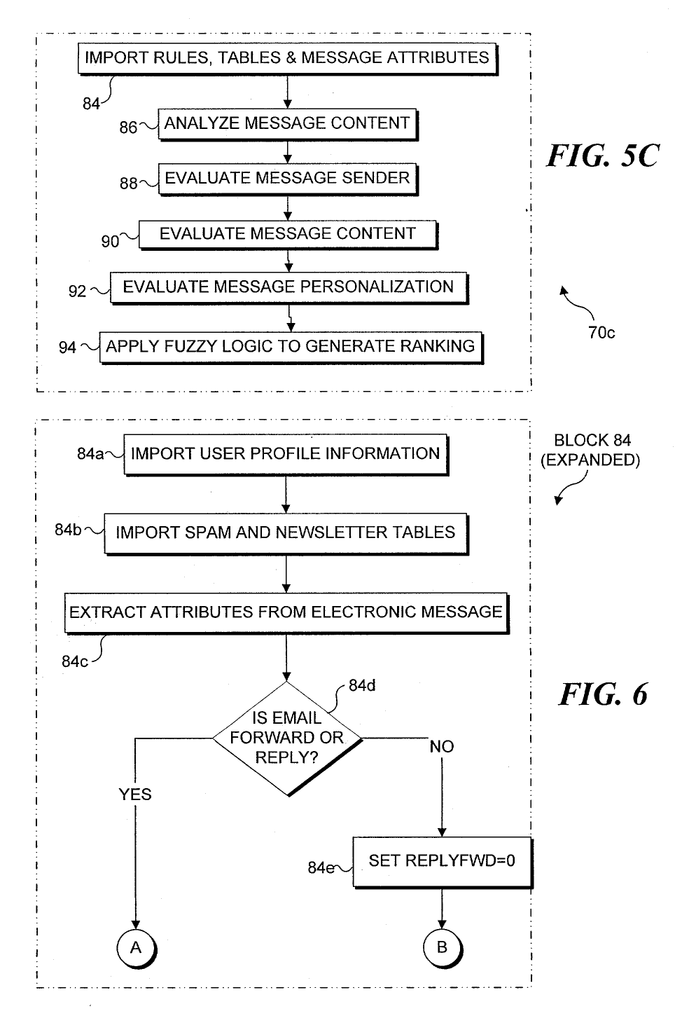

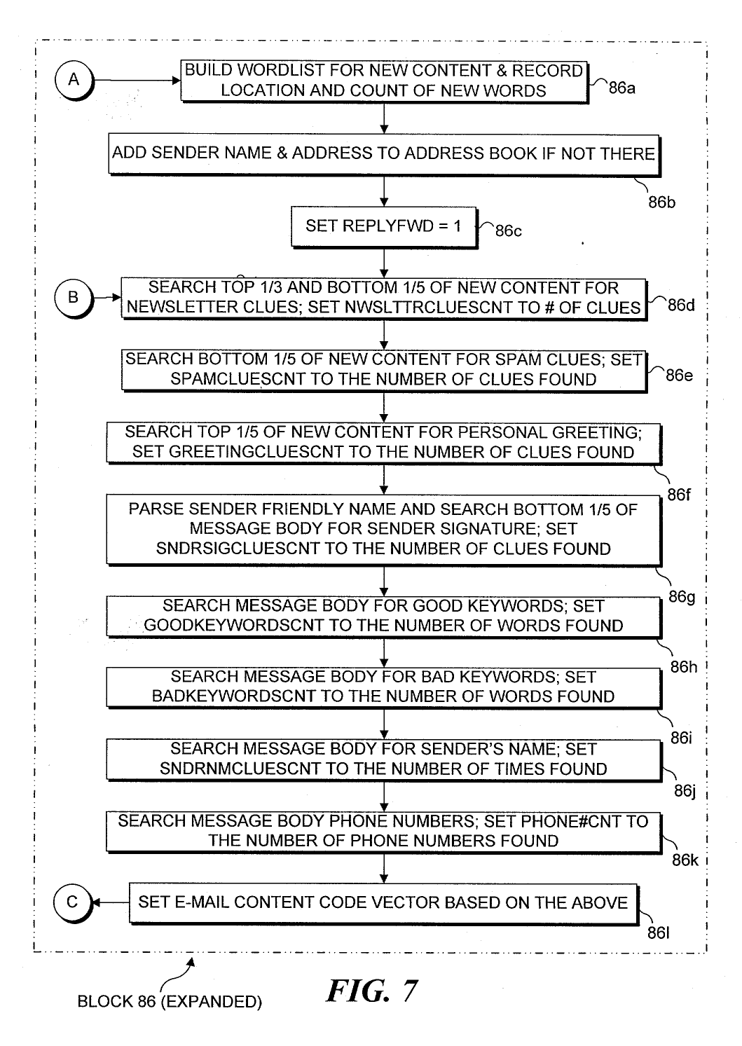

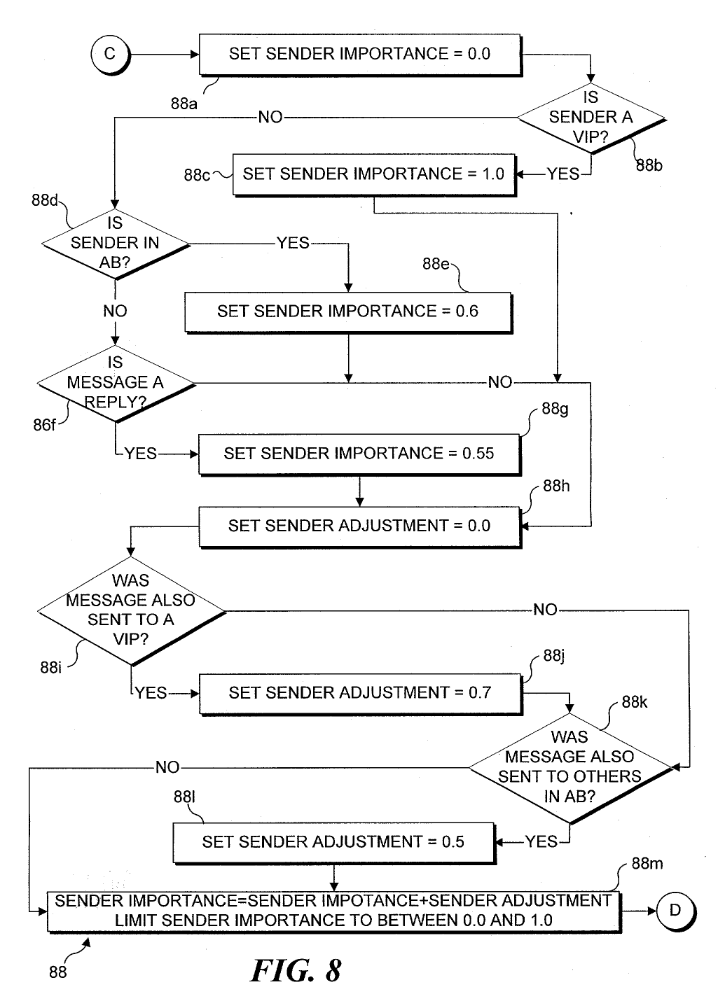

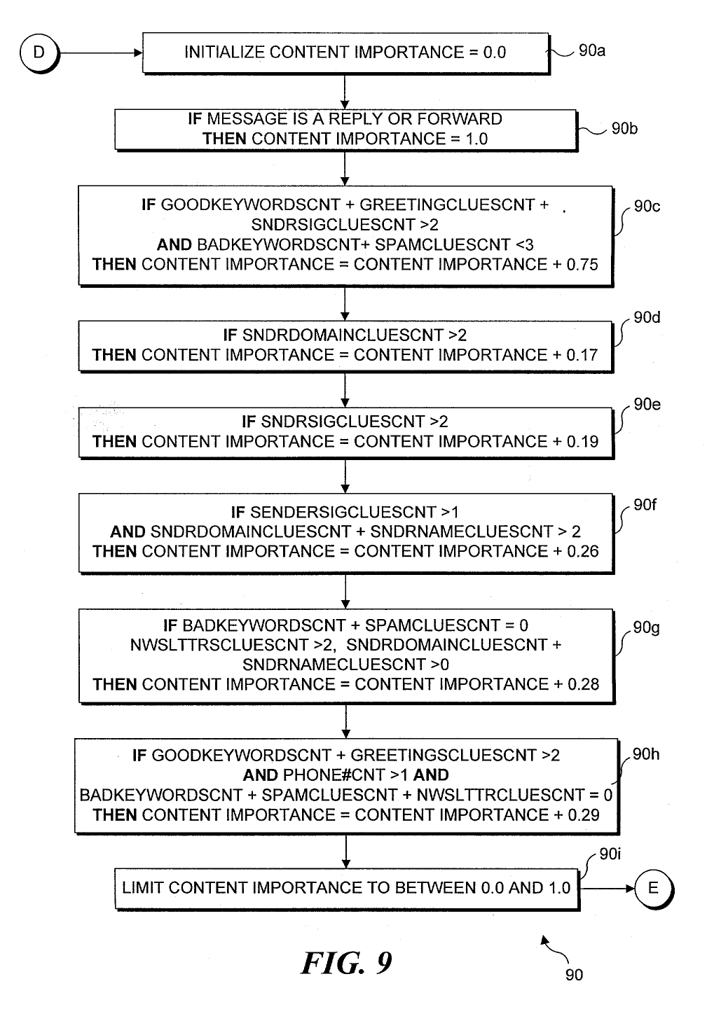

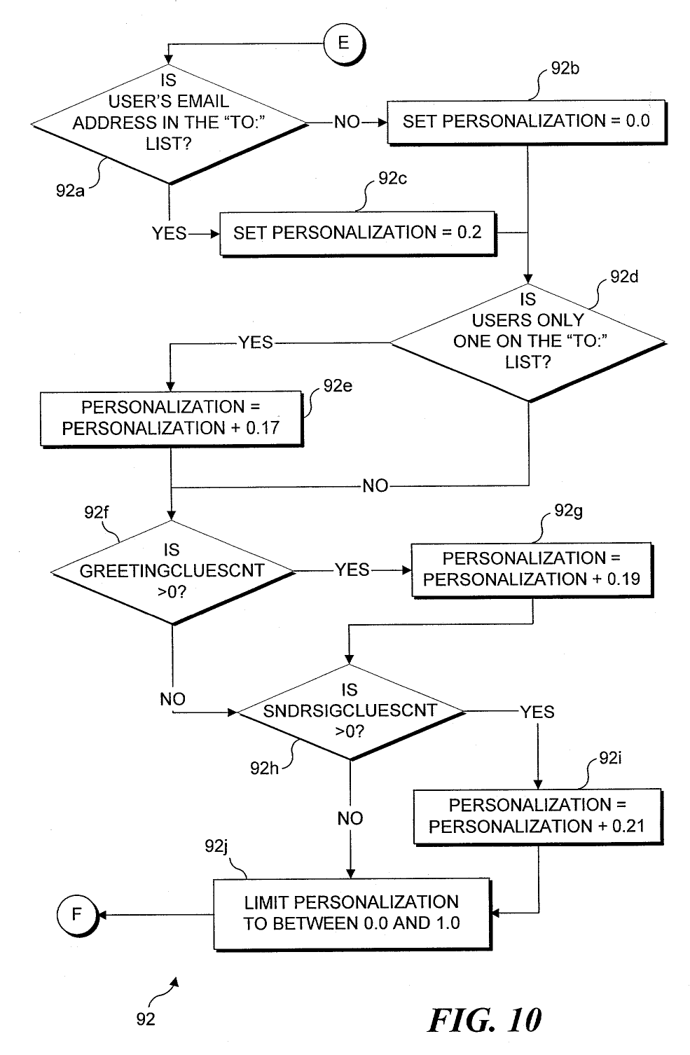

Each of the steps illustrated in FIG. 5C comprises a plurality of steps. FIGS. 6-11 each illustrate further logic for a different one of steps 84-94 shown in FIG. 5C. Thus, FIG. 6 illustrates details of the logic implemented in block 84; FIG. 7 illustrates the logic implemented in block 86; FIG. 8 illustrates details of the logic implemented in block 88; FIG. 9 illustrates details of the logic implemented in block 90; FIG. 10 illustrates details of the logic implemented in block 92; and FIG. 10 illustrates details of the logic implemented in block 94.

Referring now to FIG. 6, steps implemented to import the rules, tables, and message attributes of the electronic message are shown. In a block 84a, user profile information is imported. The user profile information includes the user's address book and preferences that have been selected by a user for handling email messages. These preferences include a list of “goodkeywords” and a list of “badkeywords” that are specified by the user. The former indicates words that suggest a particular email is likely to be of interest to the user. For example, a real estate agent might include “sales contract” as a desirable keyword, while a teacher might include “learn” and “learning” as desired keywords. Conversely, “badkeywords” correspond to profanity, sexual connotations, solicitations, etc. that a user affirmatively identifies as undesirable. It is contemplated that a pre-populated badkeywords list could be provided, to which a user can add additional undesired words. In a block 84B spam and newsletter tables are imported. These tables include data that are used to analyze message content to determine if the content represents spam or a newsletter. For example, spam or newsletters often include the term “unsubscribe,” and newsletters often exceed 500 words, while most email from individuals is considerably shorter. Spam also often includes a relatively high frequency of the characters <CR><LF> (i.e., a carriage return followed by a line feed). Those of ordinary skill in the art will appreciate that other such data indicative of spam and newsletters are known and can be beneficially incorporated in the tables used for this purpose.

In a block 84c, attributes are extracted from the electronic message. These attributes are readily determined by parsing the email, and include the sender's email address, the subject line, the email address of any additional parties to whom the email has been forwarded or copied, the alphanumeric content of the email, the word count of the body text, the number of new words in the content, the date, and the To: address list. The concept of “new words” in the content refers to examining email to determine how much of the email is new, as opposed to being part of an earlier email message. For example, many email messages, particularly replies, copy portions of an earlier email. One technique for parsing the content of an email message for new content verses old content involves looking for the phrase “original message,” and considering all content after that phrase to be old content. This works well for email messages in which the old content (i.e. the original message) follows the new content. It is anticipated that other parsing techniques can be beneficially employed to separated new content from old content. For example, if it is known that email from a certain email system places old content first, rather than last, a parsing technique can be developed and applied to such email.

In a decision block 84d, the logic determines whether the email was forwarded or is a reply to an email message from the user. It is assumed that emails that are either replies or have been forwarded are likely to be more important to a user than other types of email. If in decision block 84d, it is determined that the email is a forwarded email or a reply, the logic jumps to a block 86a shown in FIG. 7 (described in detail below). If, in decision block 84d, it is determined that the email is not a forwarded email or a reply, the logic moves to a block 84e, and the logic sets a flag REPLYFWD=0. The logic then moves to a block 86d, also in FIG. 7.

FIG. 7 shows twelve steps that are employed to analyze the message content. In block 86a, a list of words present in the new content is built, the locations of the words in the email are identified, and the total count of new words is recorded. In a block 86b, the sender's name and email address are added to the user's address book if they are not already included in the user's address book. Note that because of decision block 84d of FIG. 6, block 86b is only reached if the email has been forwarded or is a reply. Typically, spam and newsletters are not replies or forwarded, so there is little chance of the email address of a sender of spam or newsletters being added to the user's address book in block 86b. It is anticipated that the step of adding a sender's email address to the users personal address book could also be performed based on other criteria, such as the sender importance being at least 0.5. sender importance is determined according to the steps of FIG. 8 as described below. In a block 86c, the logic sets a flag REPLYFWD=1. In a block 86d, the top third and bottom fifth of the new content are searched for clues indicating that the content is a newsletter. A newsletter clues count (i.e., a variable NWSLTTRCLUESCNT) is set equal to the number of newsletter clues found. In a block 86e, the bottom fifth of the new content is searched for spam clues. A spam clues count variable (i.e., the variable SPAMCLUESCNT) is set equal to the number of words identified in the spam clues table that are found in the bottom fifth of the new content.

In a block 86f, the top fifth of the new content is searched for evidence of a personalized greeting (e.g., the word “Dear” followed by the recipient's name), and a user greeting clues count variable (i.e., the variable GREETINGCLUESCNT) is set equal to the number of personalized words that are found. In block 86g, the sender's friendly name (not the sender's email address) is parsed and the bottom fifth of the email is searched for evidence of the sender's signature (i.e. the sender's friendly name). Note that even if spam includes a personalized closing (i.e. “Thanks, Bob), the sender's signature (Bob) generally does not match the sender's friendly name. A variable indicative of a sender's signature clues count (i.e., the variable SNDRSIGCLUESCNT) is set equal to the number of instances of the sender's signature that are found. The sender's signature (i.e. senders' friendly name) may be present more than once, particularly in important email from an unknown person. For example, the following represents an email from an unknown person who is emailing a user who operates a website selling hobby materials. “Hi. I want to order (5) gizmos. My shipping address is Bob Smith, 3535 Street A, City B, State C, 98123. My email address is BobSmith@koolmail.net. Please send me a total including shipping costs and let me know how you would like payment. Thanks, Bob Smith.” Note that the sender's signature (Bob Smith) appears more than once. It is anticipated that many important emails from unknown persons will include multiple instances of the sender's signature.

In a block 86h, the message body is searched for instances of any of the user's predefined “good keywords,” as identified in the user's preferences, and a variable indicative of the good keyword count (i.e., the variable GOODKEYWORDSCNT) is set equal to the number of good keywords found. Similarly, in a block 86i, the message body is searched for any instances of “bad keywords” (also identified in the user's preferences), and a variable indicative of the bad keyword count (i.e., the variable BADKEYWORDSCNT) is set equal to the number of bad keywords found. (The lists of good keywords and bad keywords provided by the user are stored in block 20 of FIG. 1.)

In a block 86j, the message body is searched for the sender's name and a variable indicative of a sender's name clues count (i.e., the variable SNDRNMCLUESCNT) is set equal to the number of times the sender's name is found in the message body. Note that both the SNDRNMCLUESCNT and the SNDRSIGCLUESCNT (block 86g) each look for the sender's friendly name, SNDRSIGCLUESCNT looks only in the bottom 1/5 of the message body, while the SNDRNMCLUESCNT is based on the entire content. The SNDRNMCLUESCNT is used to separate spam-whose friendly name does not appear in the content, from newsletters, whose friendly name often appears in the content. The SNDRNMCLUESCNT is also used to find friendly name signatures in proximity to phone numbers, further identifying an email as being sent by a person.

In a block 86k, the message body is searched for phone numbers and a variable indicative of a phone number count (i.e., the variable PHONE#CNT) is set equal to the number of phone numbers that are found in the message body. The logic applied here is that spam and newsletters generally do not include phone numbers, and thus, an email message that includes a phone number in the content of the email is likely to be an important email message.

In a block 86l, an email content code vector is set based on the information developed in blocks 86a-86k. The logic then moves to a block 88a of FIG. 8 (described in detail below).

FIG. 8 illustrates details of the logic implemented in block 88 from FIG. 5C, and shows thirteen steps involved in analyzing the importance of the sender. This analysis is made up of two parts. In a first part (blocks 88a-88h) a base value is determined for the sender. If the sender is a VIP the sender importance is highest (equal to 1.0), if the sender is identified in the user's address book the sender importance is somewhat lower (equal to 0.6), and if the sender is replying to an email from the user the sender importance is slightly lower yet (equal to 0.55). If the sender matches none of the above characteristics, the sender importance is zero. In the second part (blocks 88i-88m), the sender importance is adjusted based on additional factors, such as whether the sender copied the email to a person identified as a VIP in the user's address book (sender importance increased by 0.7), or whether the sender copied the email to a person identified in the user's address book (sender importance increased by 0.5). A detailed description of the logical steps is provided below.

In a block 88a, a sender importance variable is initially set equal to 0.0. In a decision block 88b, it is determined whether the sender is an important person as defined in the user's preferences (e.g., one of a list of relatives/family members and close friends). If it is determined the sender is not an important person, the logic moves to a decision block 88d. Conversely, if it is determined that the sender is an important person, the logic moves to a block 88c, and the sender importance variable is set equal to 1.0. From block 88c, the logic jumps to a block 88h.

In decision block 88d, the logic determines whether the sender is listed in the user's address book. If so, the logic moves to a block 88e, and the variable indicative of the sender's importance is set equal to 0.6. From block 88e, the logic jumps to block 88h. If the sender is not listed in the user's address book in block 88d, the logic moves to a decision block 88f.

In decision block 88f, logic determines whether the message is a reply, and if not, the logic again advances to block 88h. If the message is a reply, the logic moves to a block 88g, and the sender importance variable is set equal to 0.55. From block 88g, the logic moves to block 88h, where a sender adjustment variable is set equal to 0.0.

A decision block 88i determines whether the message was sent to a very important person (identified as such in the user's address book), as well as to the recipient. If so, then the sender adjustment variable is set equal to 0.7 in a block 88j. If, in block 88i, it is determined that the message was not also sent to a very important person, the logic moves to a decision block 88k. Note that decision block 88k is reached either from decision block 88i or block 88j. Decision block 88k determines whether the message was also sent to others identified in the user's address book. If so, the sender adjustment variable is set equal to 0.5. If not, the logic moves to a block 88m, which is also reached from block 88l. In block 88m, the sender importance is defined as equal to the sum of the sender importance and the sender adjustment and is limited to a value between 0.0 and 1.0. The logic then advances to a block 90a in FIG. 9. FIG. 9 includes further details for the step of block 90 from FIG. 5C and includes nine steps involved in analyzing the importance of the content of the email. The first step is indicated in a block 90a in which a content importance variable is initialized as equal to 0.0. In a block 90b, if the message is a reply or was forwarded, then the content importance variable is set equal to 1.0. In a block 90c, if the sum of the good keywords count, the greeting clues count, and the sender's signature clues count variables is greater than two (i.e., if GOODKEYWORDSCNT+GREETINGCLUESCNT)+SNDRSIGCLUESCNT>2), and if the sum of the bad key word count and spam clues count variables is less than three (i.e., if BADKEYWORDSCNT+SPAMCLUESCNT<3), then content importance equals content importance (i.e., its previous value) plus 0.75.

In a block 90d, if the value of the sender domain clues count variable is greater than two (i.e., if SNDRDOMAINCLUESCNT>2), then content importance equals the value of the content importance (i.e., its previous value) plus 0.17. SNDRDOMAINCLUESCNT refers to the number of times the sender's domain appears in the body of the email. By analyzing thousands of spammed email it has been determined that the sender's domain rarely appears in email that is spam. Emails from unknown persons often include the sender's email address as part of the email content, and thus the presence of the sender's domain is often part of the content of such email. Referring once again to the sample email noted above, note that the sender's domain name is present. “Hi. I want to order (5) gizmos. My shipping address is Bob Smith, 3535 Street A, City B, State C, 98123. My email address is BobSmith@koolmail.net. Please send me a total including shipping costs and let me know how you would like payment. Thanks, Bob Smith.”

In a block 90e, if the value of the signature clues count variable is greater than two (SNDRSIGCLUESCNT>2), then the value of the content importance equals content importance (i.e., its previous value) plus 0.19. In a block 90f, if sender's signature clues count is greater than one (SNDRSIGCLUESCNT>1) and sender domain clues count plus sender name clues count is greater than two (i.e., if SNDRDOMAINCLUESCNT+SNDRNMCLUESCNT>2), then the content importance is incremented by 0.26.

In a block 90g, if the sum of the bad words count variable and the spam clues count variable equals zero (i.e., if BADKEYWORDSCNT+SPAMCLUESCNT=0), if the newsletter clues count variable has a value greater than two (NWSLTTRCLUESCNT>2), and if the sum of the sender domain clues count and sender names clues count variable is greater than zero (i.e., if SNDRDOMAINCLUESCNT+SNDRNMCLUESCNT>0), then the content importance in incremented by 0.28.

In a block 90h, if the value of the sum of the good keywords count and greeting clues count variables is greater than two (i.e., if GOODKEYWORDSCNT+GREETINGCLUESCNT>2), if the phone number count variable is greater than one (PHONE#CNT>1), and if the sum of the bad keywords count, spam clues count, and newsletter clues count variables equals zero (i.e., if BADKEYWORDSCNT+SPAMCLUESCNT+NWSLTTRCLUESCNT=0), then the value of the content importance variable is incremented by 0.29. In a block 90i, the content importance is limited to the range between 0.0 and 1.0. The logic then moves to a block 92 (FIG. 5C), details of which are illustrated in FIG. 10, as described below.

FIG. 10 illustrates ten different individual steps that are implemented in determining the extent to which an email message is personalized with respect to the recipient. A decision block 92a determines if the user's email address is in the “TO:” line of the email message that was received. If not, the personalization variable is set equal to 0.0 in a block 92b. If, in block 92a, it is determined that the user's email address is in the “TO:” line, then in a block 92c, the personalization variable is set equal to 0.2. From both blocks 92c and 92b, the logic moves to a decision block 92d.

In decision block 92d it is determined if the user is the only one identified in the “TO:” line of the email. If so, in a block 92e the personalization is incremented by 0.17. If in block 92d it is determined that the user is not the only one on the “TO:” line of the email, the logic moves to a decision block 92f. Note that decision block 92f is also reached from block 92e.

Decision block 92f determines if the value of the greeting clues count variable is greater than zero (i.e., if GREETINGCLUESCNT>0), and if so, the personalization count is incremented by 0.19 in a block 92g. If not, the logic moves to a decision block 92h, which is also reached from block 92g.

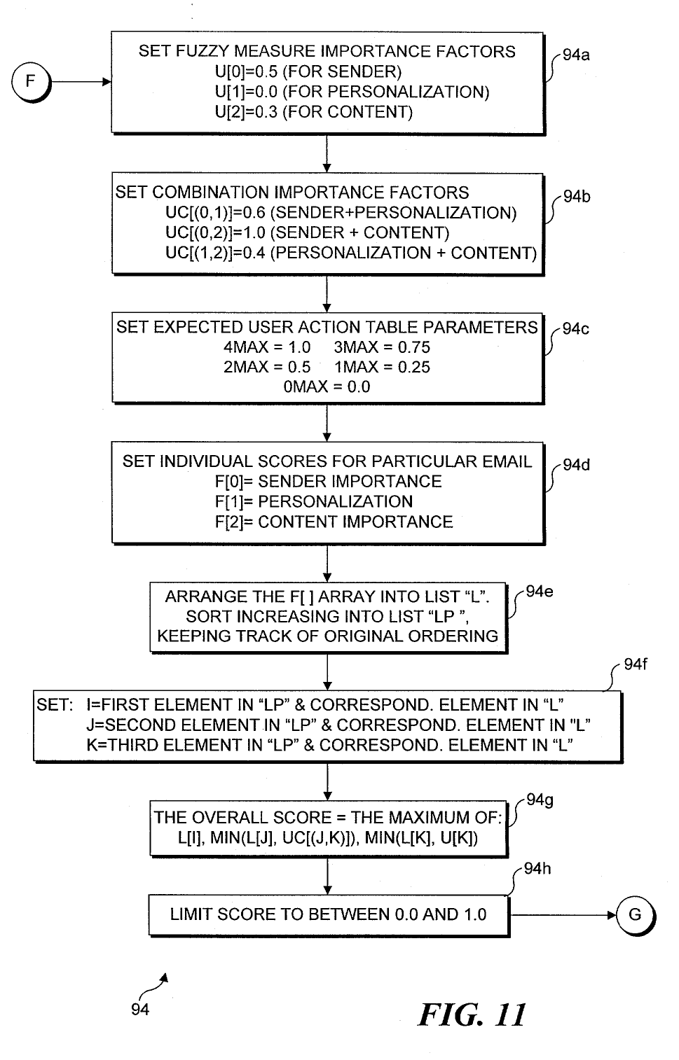

Decision block 92h determines if the sender's signature count is greater than zero (SNDRSIGCLUESCNT>0). If so, the personalization is increment by 0.21 in a block 92i. If not, the logic moves to a block 92j, and the personalization count variable value is limited between zero and 1.0. Note that block 92j is also reached from block 92i. The logic then advances to a block 94a in FIG. 11, which is described in detail below.

As shown in FIG. 11 block 94 of FIG. 5C is carried out with eight steps that apply fuzzy logic to the previously determined parameters, including the sender's importance, the importance of the email's content, and the degree with which the email is personalized with respect to the recipient. It is contemplated that fuzzy logic can also be employed in determining each or any of these parameters, as illustrated in FIGS. 5A and 5B. In the preferred embodiment illustrated in FIG. 5C, the fuzzy logic is employed after each parameter has been determined.

Referring to FIG. 11, in a block 94a, the fuzzy measure importance factors are initially set. Specifically, the sender importance variable is set equal to 0.5, the personalization importance variable is set equal to 0.0, and the content importance factor variable is set equal to 0.3. In mathematical terms, an array U is defined with these three elements, so that a first element 0 corresponds to the sender importance (thus, U[0]=0.5). A second element 1 corresponds to the personalization importance (i.e., U[1]=0.0), and a third element 2 corresponds to the content importance (i.e., U[2]=0.3).

In block 94b, the combination importance factors are set. In this step, the combination of sender plus personalization is set to equal 0.6, the combination of sender plus content is set to equal 1.0, and the combination of personalization plus content is set to equal 0.4. Expressed mathematically, an array UC is defined, also with three elements. A first element (0,1) corresponds to element 0 (sender importance) and element 1 (personalization importance) of array U (i.e., UC[(0,1)]=0.6). A second element (0,2) corresponds to element 0 (sender importance) and element 2 (content importance) of array U (i.e., UC[(0,2)]=1.0), and a third element (1,2) corresponds to element 1 (personalization importance) and element 2 (content importance) of array U (i.e., UC[(1,2)]=0.4).

In a block 94c, the maximum values corresponding to the expected user action table parameters are set so that four max equals 1.0 (i.e., 4 MAX=1.0), three max equals 0.75 (i.e. 3 MAX=0.75), two max equals 0.50 (i.e. 2 MAX=0.5), one max equals 0.25 (i.e. 1 MAX=0.25), and zero max equals 0.0 (i.e. 0 MAX=0.0). In a block 94d, the individual scores for a particular email are employed to define an array F, where element 0 corresponds to that email sender's importance (F[0]=sender importance), element 1 corresponds to that email's personalization (F[1]=personalization), and element 2 corresponds to that email's content importance (F[2]=content importance).

In a block 94e the elements of array F are arranged into a list “L” (where L=sender importance, personalization, content importance). The elements of array F are sorted in increasing order and used to populate a list “LP” (e.g., LP=sender importance, personalization, and content importance, where sender importance>personalization>content importance).

In a block 94f, “I” is defined as both the first element in List “LP” and the corresponding element in List “L.” Element “J” is defined as both the second element in List “LP” and the corresponding element in List “L.” Element “K” is defined as both the third element in List “LP” and the corresponding element in List “L.” Thus LP=(I, J, K) and I>J>K.

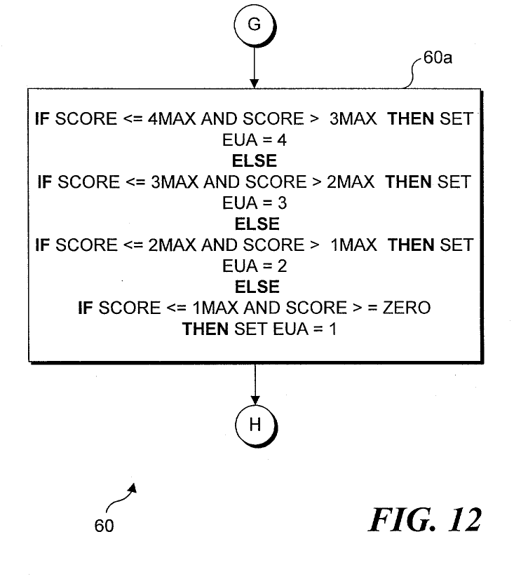

In a block 94g, the overall score is defined as the maximum of: (a) element I of array L; (b) the minimum of element J of array and element (J,K) of array UC; and (c) the minimum of element K of array L and element K of array U. Mathematically, the overall score is the maximum of: L[I], MIN(L[J], UC[(J,K)]), and MIN(L[K], U[K]). Note that array L and array F include the same elements. However, array F is not arranged in any specific order, whereas array L is an ordered array in which all the elements of array F are placed in increasing order. Referring now to a block 94h, the resulting score is limited to the range between 0.0 and 1.0. The logic then moves to block 60a as shown in FIG. 12.

Block 60a of FIG. 12 includes details for the step in which each electronic message is categorized based on the ranking determined by using fuzzy logic. As can be seen from block 60a, four categories correspond to four expected user actions (EUA). Each email is placed into one of the four categories based on the email message's final score (block 94h of FIG. 11). If the final score is less than or equal to 1.0 (4MAX), but greater than 0.75 (3MAX), then EUA is set equal to 4. If the final score is less than or equal to 0.75 (3MAX), but greater than 0.5 (2MAX), then EUA is set equal to 3. If the final score is less than or equal to 0.5 (2MAX), but greater than 0.25 (1MAX), then EUA is set at 2. Otherwise, if the final score is less than or equal to 0.25 (1MAX), but greater than 0.0 (0MAX), then EUA is set equal to 1.

For a specific email message, an EUA=4 indicates that the recipient is expected to read the email, reply to the email, and save the email. An EUA=3 indicates that the recipient is expected to read and save the email. An EUA=2 indicates that the recipient is expected to only save the email, and an EUA=1 indicates that the recipient is expected to delete the email without reading it.

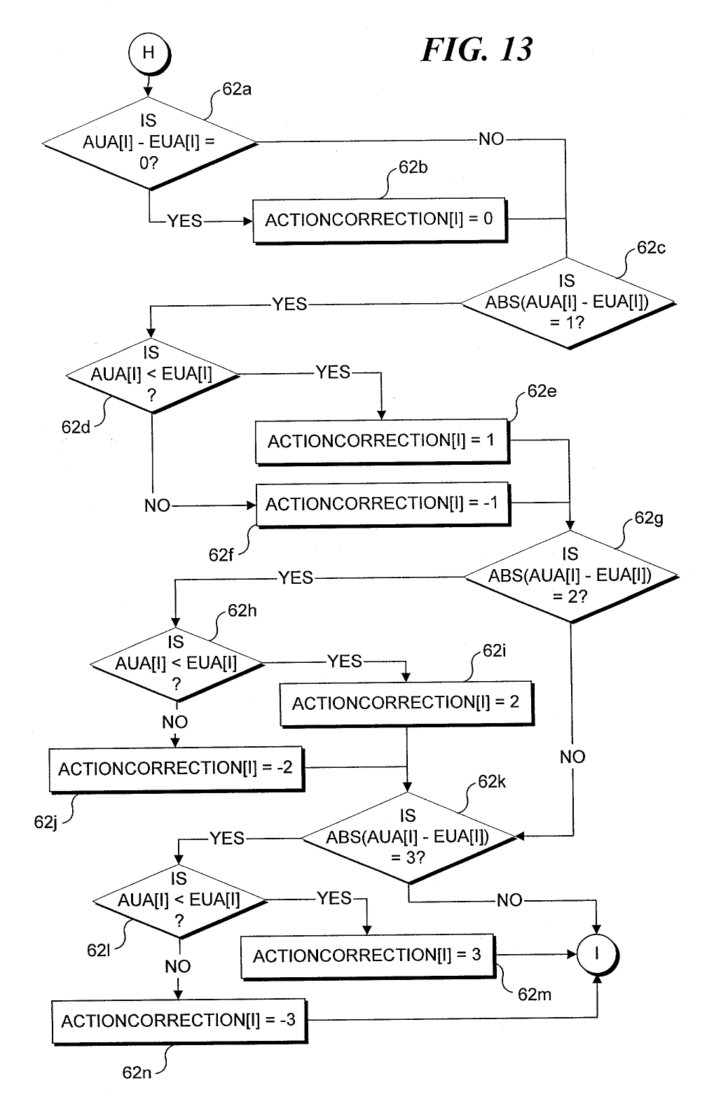

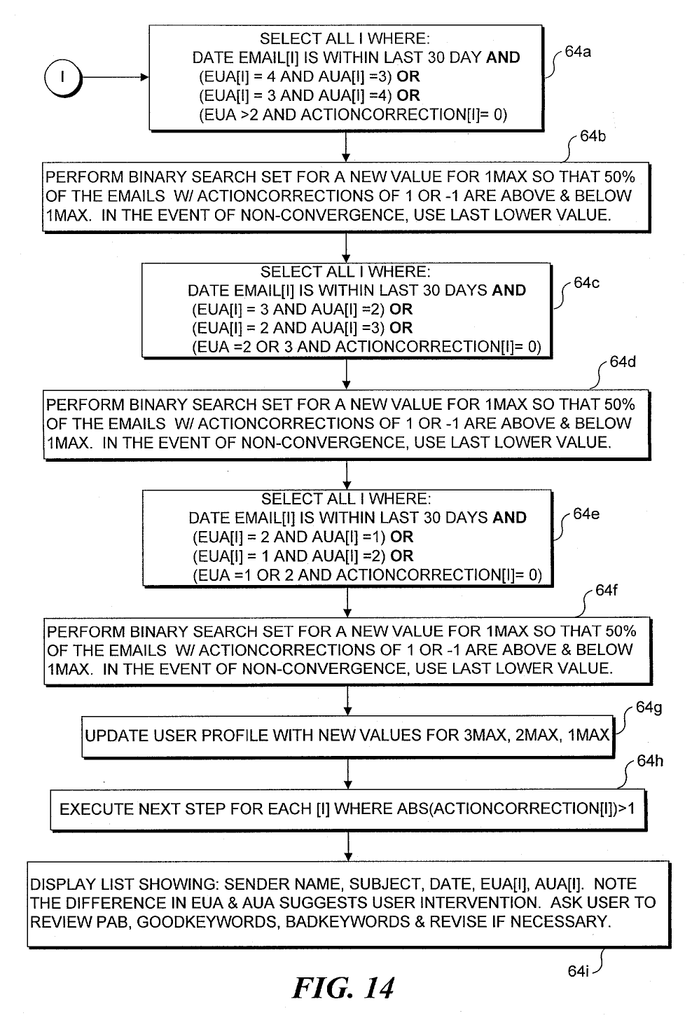

FIGS. 13 and 14 illustrate steps utilized to provide the optional dynamic update feature of the present invention. Referring to FIG. 13, in a decision block 62, the logic compares an actual user action (AUA) in response to the receipt of the email with the EUA. The value of the AUA corresponds to the actual response of the recipient in response to the email message in the same categories used for the EUA. Note that the EUA is determined using the steps described above in regard to FIG. 12. Specifically, decision block 62a determines if the value representing the AUA (i.e., 4, 3, 2, or 1) for a message I less the value of the EUA for message I is equal to 0 (i.e., if AUA[I]−EUA[I]=0?). If that condition is true, then the logic proceeds to a block 62b, and an action correction counter variable is set equal to 0 (ACTIONCORRECTION[I]=0). Next the logic moves to a decision block 62c, which determines if the value corresponding to the AUA is greater by 1 than the value of the EUA (i.e., if AUA[I]−EUA[I]=1). Note that if the condition in decision block 62a is false, the logic moves immediately to decision block 62c.

If the condition in decision block 62c is true, then the action correction counter is set to 1 (i.e., ACTIONCORRECTION[I]=1) in a block 62e, and the logic proceeds to a decision block 62g. If the condition in block 62c is false (AUA[I]−EUA[I]≠1) then the action correction counter is set to −1 (ACTIONCORRECTION[I]=−1) in a block 62f, and the logic then also proceeds to decision block 62g.

In decision block 62g, the AUA and EUA are compared to determine if the absolute value of the difference between the AUA and the EUA is equal to 2 (ABS(AUA[I]−EUA[I])=2). If the condition in decision block 62g is true, the logic proceeds to a decision block 62h, while if the condition in block 62g is false the logic proceeds to a decision block 62k.

The logic in decision block 62h determines whether the value corresponding to the AUA is less than the value corresponding to the EUA (AUA[I]<EUA[I]?). If the condition in decision block 62h is true, the action correction counter is set equal to 2 (i.e., ACTIONCORRECTION[I]=2) in a block 62i, and the logic proceeds to a decision block 62k. If the condition in decision block 62h is false (i.e., AUA[I]>EUA[I]) then the action correction counter is set to −2 (i.e., ACTIONCORRECTION[I]=−2) in a block 62j, and the logic then also proceeds to decision block 62k.

In decision block 62k (which is reached from either decision block 62g, block 62i or block 62j), the AUA and EUA are compared to determine if the absolute value of the difference between the AUA and the EUA is equal to 3 (i.e., ABS(AUA[I]−EUA[I])=3). If the condition in decision block 62k is true, the logic proceeds to a decision block 62l, while if the condition in decision block 62k is false, the logic moves to a block 64a in FIG. 14.

In block 62l (which is reached from either decision block 62g, block 62i, or block 62j), the AUA and EUA are compared to determine if the absolute value of the difference between the AUA and the EUA is equal to 3 (i.e., ABS(AUA[I]−EUA[I])=3). If the condition in decision block 62k is true, the logic proceeds to a block 62l, while if the condition in decision block 62k is false, the logic moves to block 64a in FIG. 14.

The logic in decision block 62l once again determines whether the value corresponding to the AUA is less than the value corresponding to the EUA (i.e., if AUA[I]<EUA[I]). This step is identical to the step of decision block 62h. If the condition in block 62l is true then the action correction counter is set equal to 3 (i.e., ACTIONCORRECTION[I]=3) in a block 62m, and the logic proceeds to block 64a in FIG. 14. If the condition in decision block 62l is false (i.e., if AUA[I]>EUA[I]), then the action correction counter is set equal to −3 (i.e., ACTIONCORRECTION[I]=−3) in a block 62n, and the logic then also proceeds to block 64a in FIG. 14.

Referring now to FIG. 14, once it has been determined how the AUA varies (if at all) from the EUA according to the steps described above in regard to FIG. 13, the rules are updated as required so that the EUAs determined for future emails are determined with greater accuracy. The steps employed in updating the rules can only be executed after a user has an opportunity to respond to an email message (before such a response, the AUA cannot yet be fully determined). For embodiments that utilize the dynamic update process described below, the EUA table described in block 94c of FIG. 11 represents a default table that has not yet been modified by dynamic updating for any email messages. When employed, the dynamic updating process described below will make changes to the default EUA table of block 94c and will thereafter further refine the table in response to further differences between the AUA and EUA. Preferably, the dynamic update process is executed after a predefined time period has elapsed in which the default data are used. This predefined time period is preferably set to seven days by default. Note that if the time period is too short, it is likely the user will not have time to respond to many, if any, of the email messages. It is contemplated that it may be preferable to enable the user to select a desired predefined time period that should elapse between dynamic updates.

The dynamic update process is initiated in block 64a of FIG. 14. The first step is to select all emails received within the last 30 days (DATE EMAIL[I] IS WITHIN LAST 30 DAYS) for which one the following conditions are true: (a) the number corresponding to the EUA is 4 (EUA[I]=4) and the number corresponding to the AUA is 3 (AUA[I]=3); (b) the number corresponding to the EUA is 3 (EUA[I]=3) and the number corresponding to the AUA is 4 (AUA[I]=4); (c) the number corresponding to the EUA is greater than 2 (EUA[I]>2), and the action correction is equal to zero (i.e., ACTIONCORRECTION[I]=0).

The logic then moves to a block 64b, and a binary search is performed to determine a new value for 3MAX such that 50 percent of the email messages with action corrections of 1 or −1 (ACTIONCORRECTION[I]=1 or ACTIONCORRECTION[I]=−1) are above and below 3MAX. If no such value can be determined (i.e., there is no such convergence), then the last lower value is selected. The last lower value refers to the lower of the last two values of index I that the binary search is oscillating between. This occurs when the number of I where ACTIONCORRECTION[I]=+/−1 is an odd number, and the binary search will not converge. The lower of the two values that do not converge is selected.

In a block 64c, all emails within the last 30 days (DATE EMAIL[I] IS WITHIN LAST 30 DAYS) are selected for which one of the following conditions are true: (a) the number corresponding to the EUA is 3 (EUA[I]=3) and the number corresponding to the AUA is 2 (AUA[I]=2); (b) the number corresponding to the EUA is 2 (EUA[I]=2), and the number corresponding to the AUA is 3 (AUA[I]=3); (c) the number corresponding to the EUA is 2 or 3 (EUA[I]=2 or EUA[I]=3) and the action correction is equal to zero (i.e., ACTIONCORRECTION[I]=0).

The logic then moves to a block 64d and a second binary search is performed to determine a new value for 2MAX such for 50 percent of the email messages with action corrections of 1 or −1 (ACTIONCORRECTION[I]=1 or ACTIONCORRECTION[I]=−1) are above and below 2MAX. If no such value can be determined (i.e., if there is no convergence) then the last lower value is selected, in the same manner as described in conjunction with block 64b.

In a block 64e all emails within the last 30 days (DATE EMAIL[I] IS WITHIN LAST 30 DAYS) are selected for which one of the following conditions are true: (a) the number corresponding to the EUA is 2 (EUA[I]=2), and the number corresponding to the AUA is 1 (AUA[I]=1); (b) the number corresponding to the EUA is 1 (EUA[I]=1), and the number corresponding to the AUA is 2 (AUA[I]=2); and (c) the number corresponding to the EUA is 1 or 2 (EUA[ii]=1 or EUA[I]=2), and the action correction is equal to zero (i.e., ACTIONCORRECTION[I]=0).

The logic then moves to a block 64f and a third binary search is performed to determine a new value for IMAX such that 50 percent of the emails with action corrections of 1 or −1 (i.e., ACTIONCORRECTION[I]=1 or ACTIONCORRECTION[I]=−1) are above and below 1MAX. If there is no convergence, then the last lower value is selected, as described above. In a block 64g, the user's profile is updated with the new values for 3MAX, 2MAX, and 1MAX.

Preferably, the step described in a block 64h is performed every Sunday at midnight, although it is apparent that other intervals and times can alternatively be employed. At the specified time, for each email where the absolute correction action is greater than 1 (ABS{ACTIONCORRECTION[I]}>1), each step indicated in a block 64i is executed. As noted in block 64i, a list is displayed that includes (for each email message): the sender's name, the email subject, the email date, the EUA, and the AUA. An explanation is provided, indicating that because the EUA did not correspond to the AUA, the user should review the list of good keywords, bad keywords, and the user's personal address book and make any revisions to those items as necessary. Use of the dynamic update and appropriate manual changes in the preceding items should greatly reduce any error in determining the EUA for email messages.

Although the present invention has been described in connection with the preferred form of practicing it and modifications thereto, those of ordinary skill in the art will understand that many other modifications can be made to the present invention within the scope of the claims that follow. Accordingly, it is not intended that the scope of the invention in any way be limited by the above description, but instead be determined entirely by reference to the claims that follow.

The invention in which an exclusive right is claimed is defined by the following:

1. A method for processing an electronic message to determine an action likely to be carried out by a recipient in response to the electronic message, comprising the steps of:
(a) parsing the electronic message to extract determinable attributes of the electronic message;
(b) applying a plurality of rules and user defined parameters to the determinable attributes of the electronic message to obtain a numerical ranking for the electronic message; and
(c) based on the numerical ranking of the electronic message, assigning one of a plurality of categories to the electronic message, each category in the plurality of categories corresponding to at least one user action a recipient can logically perform in response to receiving any electronic message.

2. The method of claim 1, wherein each of the plurality of categories comprises at least one of:
(a) reading the electronic message;
(b) replying to the electronic message;
(c) saving the electronic message; and
(d) deleting the electronic message.

3. The method of claim 1, further comprising the steps applying steps (a) through (c) to each of a plurality of electronic messages; and displaying a list of the plurality of electronic messages to the recipient, wherein the plurality of electronic messages in the list are grouped by the category assigned to each of the plurality of electronic messages.

4. The method of claim 3, further comprising the step of enabling the recipient to select a category, and to apply a function to each electronic message in the selected category, wherein the function comprises at least one of:
(a) displaying the electronic messages in the category that was selected; and
(b) deleting the electronic messages in the category that was selected.

5. The method of claim 1, wherein the step of applying the plurality of rules and user defined parameters comprises the step of employing fuzzy logic to determine the numerical ranking.

6. The method of claim 1, wherein the step of applying the plurality of rules and user defined parameters comprises the steps of:
(a) evaluating a first criteria of the electronic message;
(b) evaluating a second criteria of the electronic message; and
(c) consolidating results of the evaluations to obtain a numerical result corresponding to the numerical ranking of the importance of the electronic message.

7. The method of claim 6, wherein the step of evaluating a first criteria of the electronic message comprises the step of employing fuzzy logic to evaluate the first criteria.

8. The method of claim 6, wherein the step of evaluating a second criteria of the electronic message comprises the step of employing fuzzy logic to evaluate the second criteria.

9. The method of claim 6, wherein the step of consolidating the results of the evaluations to obtain the numerical result comprises the step of employing fuzzy logic to consolidate the results of the evaluations.

10. The method of claim 6, wherein at least one of the steps of evaluating a first criteria of the electronic message and evaluating a second criteria of the electronic message comprises the step of employing fuzzy logic to evaluate that criteria, and the step of consolidating the results of the evaluations comprises the step of employing fuzzy logic to consolidate the results of the evaluations.

11. The method of claim 1, wherein the step of applying the plurality of rules and user defined parameters comprises the step of evaluating the importance of the sender of the electronic message.

12. The method of claim 11, wherein the step of evaluating the importance of the sender of the electronic message comprises the step of using at least one of:
(a) addressing attributes of the electronic message;
(b) subject line attributes of the electronic message;
(c) context text attributes of the electronic message;
(d) a user defined address book; and
(e) a user defined profile.

13. The method of claim 11, wherein the step of evaluating the importance of the sender of the electronic message comprises the step of determining at least one of:
(a) whether the address of the sender of electronic message is in the user's address book;
(b) whether the sender of the electronic message is a person;
(c) whether the electronic message is a newsletter;
(d) whether the electronic message includes at least one of a nickname, a telephone number, and a company name that is in the user's address book.

14. The method of claim 13, wherein the step of determining whether the sender of the electronic message is a person comprises the step of determining whether the electronic message includes at least one indication that the electronic message was automatically transmitted.

15. The method of claim 13, wherein the step of determining whether the electronic message is a newsletter comprises the step of determining at least one of:
(a) whether the electronic message includes at least one clue that is indicative of an automatically transmitted electronic message;
(b) whether the electronic message is free from undesired keywords;
(c) whether the electronic message is free from spam clues; and
(d) whether the sender of the electronic message is a person.

16. The method of claim 1, wherein the step of applying the plurality of rules and user defined parameters comprises the step of evaluating a degree of personalization of the electronic message with respect to the recipient by using the determinable attributes that comprise at least one of:
(a) context text attributes of the electronic message;
(b) an address book of the recipient; and
(c) a user defined profile for the recipient.

17. The method of claim 16, wherein the step of evaluating the degree of personalization of the electronic message with respect to the recipient comprises the step of determining at least one of:
(a) whether the electronic message is addressed only to the recipient;
(b) whether the electronic message has been copied to any other recipient;
(c) whether the sender of the electronic message is a person;
(d) whether the electronic message includes a personalized greeting matching a nickname of the recipient; and
(e) whether the electronic message includes a personalized signature for a sender of the electronic message.

18. The method of claim 17, wherein the step of determining if the sender of the electronic message is a person comprises the step of determining at least one of:
(a) whether the sender has a valid address for receiving electronic messages;
(b) whether the sender has a nickname; and
(c) whether an address for receiving electronic messaging sent to the sender of the electronic message is included in the address book of the recipient.

19. The method of claim 1, wherein the step of applying the plurality of rules and user defined parameters comprises the step of evaluating the importance of a content of the electronic message by using the determinable attributes and user defined parameters, which comprise at least one of:
(a) subject line attributes of the electronic message;
(b) context text attributes of the electronic message;
(c) an address book of the recipient; and
(d) a user defined profile for the recipient.

20. The method of claim 19, wherein the step of evaluating the importance of the content of the electronic message comprises the step of determining at least one of:
(a) whether the electronic message includes spam clues;
(b) whether the electronic message includes newsletter clues;
(c) whether the electronic message exceeds a specified number of words;
(d) whether the electronic message includes a personalized greeting for the recipient;
(e) whether there is a personalized signature of a sender of the electronic message;
(f) whether the electronic message includes predefined desired keywords; and
(g) whether the electronic message includes at least one of a nickname, a telephone number, and a company name that is in the user's address book.

21. The method of claim 1, wherein the step of applying a plurality of rules and user defined parameters comprises the steps of:
(a) evaluating an importance of a sender of the electronic message;
(b) evaluating a degree of personalization of the electronic message with respect to the recipient; and
(c) evaluating an importance of a content of the electronic message.

22. The method of claim 1, further comprising the step of determining an action of the recipient performed in response to receiving the electronic message; and if that action does not correspond to the category assigned to the electronic message, updating the plurality of rules based on the determinable attributes of the electronic message and user defined parameters, so that a category corresponding to the action of the recipient is assigned to future electronic messages that are substantially similar to the electronic message.

23. The method of claim 1, further comprising the step of forwarding the electronic message to a portable device for action by the recipient, if the category assigned to the electronic message was chosen by the recipient.

24. The method of claim 23, wherein the portable device comprises at least one of a wireless phone, a pager, and a personal digital assistant that is useful for displaying electronic messages in the category selected by the recipient.

25. The method of claim 23, wherein the category associated with the electronic message that is selected by the recipient is associated with the reading of the electronic message.

26. An article of manufacture adapted for use with a computing device, comprising:
(a) a memory medium; and
(b) a plurality of machine instructions comprising a computer program, which are stored on the memory medium, said plurality of machine instructions when executed by a computer, causing the computing device to:
(i) parse the electronic message to extract determinable attributes of the electronic message;
(ii) apply a plurality of rules and user defined parameters to the determinable attributes of the electronic message to obtain a numerical ranking for the electronic message; and
(iii) based on the numerical ranking of the electronic message, assign one of a plurality of categories to the electronic message, each category in the plurality of categories corresponding to at least one user action a recipient can logically perform in response to receiving any electronic message.

27. The article of manufacture of claim 26, wherein the plurality of machine instructions, when executed by a computer, cause the computer to employ fuzzy logic to obtain the numerical ranking of the importance of the electronic message.

28. A system for ranking the importance of electronic messages to determine a likely response by a recipient of the electronic messages, comprising:
(a) a memory in which a plurality of rules and user defined parameters, and a plurality of machine instructions are stored;
(b) a display; and
(c) a processor that is coupled to the memory to access the machine instructions and to the display, said processor executing said machine instructions and thereby implementing a plurality of functions, including:
(i) parsing the electronic messages to extract determinable attributes of the electronic messages;
(ii) applying a plurality of rules and user defined parameters to the determinable attributes of the electronic messages to obtain a numerical ranking for the electronic messages; and
(iii) based on the numerical ranking of the electronic messages, assigning one of a plurality of categories to each of the electronic messages, each category in the plurality of categories corresponding to at least one user action a recipient can logically perform in response to receiving any electronic message.

29. The system of claim 28, wherein the plurality of functions further include using fuzzy logic to obtain the numerical ranking of the importance of the electronic messages.

30. A method for processing an electronic message using fuzzy logic, the method comprising the steps of:
(a) providing a plurality of rules based on determinable attributes of an electronic message and user defined parameters;
(b) parsing the electronic message to produce the determinable attributes of the electronic message; and
(c) applying the plurality of rules and the user defined parameters using fuzzy logic, to obtain a numerical ranking of the importance of the electronic message.

31. The method of claim 30, further comprising the steps of:
(a) providing a plurality of categories, each category corresponding to at least one user action a recipient can logically perform in response to receiving any electronic message; and
(b) based on the numerical ranking of the electronic message, assigning one of the plurality of categories to the electronic message to indicate an expected action of the recipient in responding to the electronic message.

32. The method of claim 31, further comprising the steps of processing a plurality of electronic messages by applying steps (a) through (c) to each of the plurality of electronic messages; and displaying to the recipient electronic messages to which at least one category has been assigned, from a list of the plurality of electronic messages, wherein the electronic messages in the list are grouped by the categories assigned to the plurality of electronic messages in the list.

33. The method of claim 32, further comprising the step of enabling the recipient to select a category from among the plurality of categories, and to apply a function to each electronic message to which the selected category has been assigned, wherein the function comprises at least one of:
(a) displaying the electronic messages to which the category selected was assigned; and
(b) deleting the electronic messages to which the category selected was assigned.

34. The method of claim 31, wherein each of the plurality of categories is associated with at least one of:
(a) reading the electronic message;
(b) replying to the electronic message;
(c) saving the electronic message; and
(d) deleting the electronic message.

35. The method of claim 30, wherein the step of providing a plurality of rules based on determinable attributes of the electronic message and user defined parameters comprises the steps of:
(a) providing rules used to evaluate the importance of a sender of the electronic message;
(b) providing rules used to evaluate a degree of personalization of the electronic message with respect to the recipient; and
(c) providing rules used to evaluate the importance of the content of the electronic message.

36. The method of claim 35, wherein the step of applying the plurality of rules and the user defined parameters using fuzzy logic comprises the steps of using fuzzy logic to determine at least one of:
(a) the importance of the sender of the electronic message;
(b) the degree of personalization of the electronic message with respect to the recipient; and
(c) the importance of the content of the electronic message.

37. The method of claim 35, wherein the step of applying the plurality of rules and the user defined parameters using fuzzy logic comprises the step of using fuzzy logic after the importance of the sender of the electronic message has been determined, the degree of personalization of the electronic message with respect to the recipient has been determined, and the importance of the content of the electronic message has been determined, to obtain the numerical ranking of the importance of the electronic message.

38. The method of claim 35, wherein the step of providing a plurality of rules and user defined parameters used to evaluate the importance of the sender of the electronic message comprises the step of providing rules and user defined parameters that evaluate the importance of the sender of the electronic message by using at least one of:
(a) addressing attributes of the electronic message;
(b) subject line attributes of the electronic message;
(c) context text attributes of the electronic message;
(d) an address book for the recipient; and
(e) a user defined profile for the recipient.

39. The method of claim 38, wherein the step of providing rules and user defined parameters to evaluate the importance of the sender comprises the steps of providing rules used to determine at least one of:
(a) whether an address of the sender of electronic message is in the address book;
(b) whether the sender of the electronic message is a person;
(c) whether the electronic message is a newsletter; and
(d) whether the electronic message includes at least one of a nickname, a telephone number, and a company name that is in the address book.

40. The method of claim 39, wherein the step of providing rules and user defined parameters used to determine whether the sender of the electronic message is a person comprises the step of determining whether the electronic message includes at least one indication that the electronic message was automatically sent.

41. The method of claim 39, wherein the step of providing rules and user defined parameters used to determine whether the electronic message is a newsletter comprises the steps of providing rules used to determine at least one of:
(a) whether the electronic message includes at least one indication that the electronic message was automatically sent;
(b) whether the electronic message is free from predefined undesired keywords;
(c) whether the electronic message is free from spam clues; and
(d) whether the sender of the electronic message is a person.

42. The method of claim 35, wherein the plurality of rules used to evaluate the degree of personalization of the electronic message with respect to the recipient by using at least one of:
(a) context text attributes of the electronic message;
(b) an address book of the recipient; and
(c) a user defined profile for the recipient.

43. The method of claim 42, wherein the step of providing rules that evaluate the degree of personalization of the electronic message with respect to the recipient employ the rules to determine at least one of:
(a) whether the electronic message is addressed only to the recipient;
(b) whether the electronic message has been copied to any other recipient;
(c) whether the sender of the electronic message is a person;
(d) whether the electronic message includes a personalized greeting for the recipient; and
(e) whether there is a personalized signature for the sender.

44. The method of claim 43, wherein the rules used to determine if the sender of the electronic message is a person determine at least one of:
(a) whether the sender has a valid address for receiving electronic messages;
(b) whether the sender has a nickname; and
(c) whether an address of the sender for receiving electronic messages is included in the address book.

45. The method of claim 35, wherein the rules used to evaluate the importance of the content of the electronic message by using at least one of:
(a) subject line attributes of the electronic message;
(b) context text attributes of the electronic message;
(c) an address book of the recipient; and
(d) a user defined profile for the recipient.

46. The method of claim 45, wherein the rules used to evaluate the importance of the content of the electronic message determine at least one of:
(a) whether the electronic message includes spam clues;
(b) whether the electronic message includes newsletter clues;
(c) whether the electronic message exceeds a specified number of words;
(d) whether the electronic message includes a personalized greeting matching a nickname of the recipient;
(e) whether there is a personalized signature that includes a nickname of the sender;
(f) whether the electronic message includes predefined desired keywords; and
(g) whether the electronic message includes at least one of a nickname, a telephone number, and a company name that is in the address book of the recipient.

47. The method of claim 31, further comprising the step of determining a action of the recipient in response to receiving the electronic message; and if that response does not correspond to an expected action corresponding to the category assigned to the electronic message, updating the plurality of rules based on the determinable attributes of an electronic message and user defined parameters, so that a category is more accurately assigned to substantially similar future electronic messages.

48. An article of manufacture adapted for use with a computing device, comprising:
(a) a memory medium; and
(b) a plurality of machine instructions comprising a computer program, which are stored on the memory medium, said plurality of machine instructions when executed by a computing device, causing the computing device to:
(i) access a plurality of rules based on determinable attributes of an electronic message and user defined parameters;
(ii) parse the electronic message to identify the determinable attributes of the electronic message; and
(iii) apply the plurality of rules and the user defined parameters to the determinable attributes, using fuzzy logic, to obtain a numerical ranking of the importance of the electronic message.

49. The article of manufacture of claim 48, wherein the plurality of machine instructions when executed by a computer further cause the computer to assign the electronic message to one of a plurality of different categories based on the numerical ranking of the electronic message, wherein each category is associated with at least one expected action a recipient might perform in response to receiving the electronic message.

50. A system for ranking the importance of electronic messages before the electronic messages are reviewed by the recipient; the system comprising:
(a) a memory in which a plurality of rules based on determinable attributes of electronic messages and user defined parameters, and a plurality of machine instructions are stored;
(b) a display; and
(c) a processor that is coupled to the memory to access the machine instructions and to the display, said processor executing said machine instructions, which cause the processor to execute a plurality of functions, including:
(i) identifying determinable attributes of the electronic messages;
(ii) analyzing the electronic messages using the plurality of rules, based on the determinable attributes of the electronic message, and by applying the user defined parameters; and
(ii) applying fuzzy logic to results of the step of analyzing, to obtain a numerical ranking of the importance of each of the electronic messages.

51. The system of claim 50, wherein the plurality of functions further include assigning each of the electronic messages to one of a plurality of different categories based on the ranking of the electronic message, wherein each different category corresponds to a different expected action a recipient might perform in response to receiving an electronic message.
